(19) United States
(12) Patent Application Publication
(10) Pub. No.: US 2007/0298345 A1
(43) Pub. Date: Dec. 27, 2007

(54) Method of preparing toner and toner prepared using the method

(75) Inventors: Chang-kook Hong, Suwon-si (KR); Min-young Cheong, Seoul (KR); Yo-da Shin, Jung-gu (KR); Kyung-yol Yon, Seongnam-si (KR); Sang-soon Lim, Seocheon-gun (KR); Su-bum Park, Nam-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/635,557

(22) Filed: Dec. 8, 2006

(30) Foreign Application Priority Data
Jun. 22, 2006 (KR) 10-2006-0056541

(51) Int. Cl. G03G 9/08

(52) U.S. Cl. 430/109.3; 430/137.14; 430/123.5

(57) ABSTRACT

A method of preparing toner and a toner using the method is provided. More particularly, a method of preparing toner controls a shape of finally obtained toner particles by adjusting a molecular weight and Tg of polymer latex and can easily obtain a desired size, shape, and size distribution of toner particles by controlling aggregation of polymer latex particles and process conditions. A toner using the method, an image forming method using the toner and an image forming apparatus including the toner are also provided. The toner is prepared by forming polymer latex particles having different molecular weights by polymerizing a toner composition including macromonomers containing a hydrophilic group, a hydrophobic group and at least one reactive functional group, and at least one polymerizable monomer; and mixing the polymer latex particles having different molecular weights with a pigment dispersion solution to control aggregation of the polymer latex particles by controlling pH or an amount of added inorganic salts and optimizing process conditions.

### CROSS-REFERENCE TO RELATED PATENT APPLICATION

This application claims the benefit Under 35 U.S.C. §119(a) of Korean Patent Application No. 10-2006-0056541, filed on Jun. 22, 2006, in the Korean Intellectual Property Office, the disclosure of which is hereby incorporated by reference in its entirety.

### BACKGROUND OF THE INVENTION

1. Field of the Invention

The present invention relates to a method of preparing toner and to the toner prepared using the method. More particularly, the invention relates to a method of preparing toner in which a desired particle shape, size and size distribution of toner particles can be obtained by controlling the aggregation of polymer latex particles, The invention is further directed to the toner prepared using the method, an image forming method using the toner and an image forming apparatus including the toner.

2. Description of the Related Art

In an electrophotographic process or an electrostatic recording process, a developer used to shape an electrostatic image or an electrostatic latent image may be a two-component developer, formed of toner and carrier particles, or a one-component developer, formed of toner only. The one-component developer may be a magnetic one-component developer or a nonmagnetic one-component developer. Plasticizers such as colloidal silica are often added independently into the nonmagnetic one-component developer to increase the flowability of the toner. Generally, coloring particles obtained by dispersing a colorant, such as carbon black, or other additives in a binding resin are used in the toner.

Methods of preparing toner include a pulverization or a polymerization method. In the pulverization method, toner is obtained by melting and mixing synthetic resins with colorants and, if needed, other additives, pulverizing the resulting mixture and sorting the particles until particles of a desired size are obtained. In the polymerization method, a polymerizable monomer composition is manufactured by uniformly dissolving or dispersing a polymerizable monomer, a colorant, a polymerization initiator and, if needed, various additives such as a cross-linking agent and an antistatic agent. Next, the polymerizable monomer composition is dispersed in an aqueous dispersive medium which includes a dispersion stabilizer using an agitator to shape minute liquid droplet particles. Subsequently, the temperature is increased and suspension polymerization is performed to obtain polymerized toner having coloring polymer particles of a desired size.

In an image forming apparatus such as an electrophotographic apparatus or an electrostatic recording apparatus, an electrostatic latent image is formed by exposing the surface of a photoreceptor to light where the surface is uniformly charged. Toner is attached to the electrostatic latent image, and a resulting toner image is transferred to a transfer medium such as paper through several processes such as heating, pressing, solvent steaming, etc. In most fixing processes, the transfer medium with the toner image passes through fixing rollers and pressing rollers, and by heating and pressing, the toner image is fused to the transfer medium.

Images formed by an image forming apparatus such as an electrophotocopier should satisfy requirements of high precision and accuracy. Conventionally, toner used in an image forming apparatus is usually obtained using a pulverization method. In the pulverization method, color particles having a large range of sizes are formed. Hence, to obtain satisfactory developer properties, there is a need to sort the coloring particles obtained by the pulverization according to size to reduce the particle size distribution. However, it is difficult to precisely control the particle size distribution using a conventional mixing/pulverizing process in the manufacture of toner particles suitable for an electrophotographic process or an electrostatic recording process. Also, when preparing a minute particle toner, the toner preparation yield is low due to a sorting process. In addition, there is a limit to a change/adjustment of a toner design for obtaining desirable charging and fixing properties. Accordingly, polymerized toners, in which the size of particles is easy to control and which do not need to undergo a complex manufacturing process such as sorting, have been highlighted recently.

When toner is prepared by a polymerization process, polymerized toner with a desired particle diameter and diameter distribution can be obtained without pulverizing or sorting. However, in spite of using such a polymerization method, an emulsifying agent has been used to disperse a pigment. The use of the emulsifying agent necessarily accompanies a washing process, and thus preparation costs are increased, and an amount of the discharged wastewater is increased.

For example, U.S. Pat. No. 6,258,911 to Michael et al. discloses “bifunctional macromolecules and toner compositions therefrom” having a narrow polydispersity and a method of emulsification-aggregation polymerization which prepares a polymer having free radicals that are covalently-bonded at both ends of the polymer. In the method of emulsification-aggregation polymerization, wax and a pigment dispersion solution are separately prepared using an ionic emulsifying agent (an anionic emulsifying agent is generally used), polymer latex particles prepared using an emulsifying agent are dispersed with a wax dispersion solution and a pigment dispersion solution, and then toner particles are provided through an aggregation process. In another method, polymer latex (or seed) is polymerized in a first operation, the seed is polymerized with a wax-monomer emulsification dispersion agent using seed-treated emulsion polymerization, and then the resulting product is aggregated with a dispersed pigment dispersion solution using an emulsifying agent in the aggregation process to provide toner particles. However, in such a conventional emulsification-aggregation polymerization method, the methods are complicated, use emulsifying agent that are difficult to remove so that the emulsifying agent remains in the particles. In particular, additional processes such as a washing process, and the like are required, thereby polluting the environment, reducing economic efficiency, and prevent control of the size of latex particles.

Also, U.S. Pat. No. 6,033,822 to Hasegawa et al. discloses a polymerized toner, wherein the polymerized toner includes core particles and shells covering the core particles and is prepared by suspension polymerization. However, it is still difficult to control the shape and size of the toner particles using such a method. Moreover, the toner particle size distribution is wide.

### SUMMARY OF THE INVENTION

The present invention provides a method of preparing toner that is simple, and where the shape and size of the toner particles can be easily controlled, fixation of the toner particles to paper at a low temperature is good, and physical properties of the toner such as storage, durability, and the like are improved.

The present invention also provides toner in which the shape and size of the toner particles can be easily controlled, and having good physical properties such as storage, durability, and the like.

The present invention also provides a method of forming high quality images in which fixation of the toner particles to paper is possible using the toner where the shape and size of the toner particles can be easily controlled, and the toner has good physical properties such as storage, durability, and the like.

The present invention also provides an apparatus for forming high quality images in which fixation of the toner particles to paper is possible where the shape and size of the toner particles can be easily controlled, and the toner has good physical properties such as storage, durability, and the like.

According to an aspect of the present invention, a method of preparing toner comprises: preparing polymer latex by polymerizing a toner composition comprising macromonomers having a hydrophilic group, a hydrophobic group and at least one reactive functional group, and at least one polymerizable monomer, where the molecular weight and glass transition temperature (Tg) of the polymer latex are controlled by adjusting an amount of the macromonomers and a weight ratio of the polymerizable monomer or an amount of a chain transfer agent; and mixing the polymer latex particles with a pigment dispersion solution to control aggregation of the polymer latex particles.

According to another aspect of the present invention, a toner is obtained by forming polymer latex particle in which a molecular weight and glass transition temperature (Tg) are controlled by adjusting an amount of the macromonomers and a weight ratio of polymerizable monomer or an amount of a chain transfer agent, in polymerizing a toner composition including macromonomers having a hydrophilic group, a hydrophobic group and at least one reactive functional group, and at least one polymerizable monomers, and then by mixing the polymer latex with a pigment dispersion solution.

According to another aspect of the present invention, an image forming method is provided comprising forming a visible image by disposing toner to a surface of a photoreceptor on which an electrostatic latent image is formed and transferring the visible image to a transfer medium, the method comprising preparing polymer latex particle in which a molecular weight and glass transition temperature (Tg) are controlled by adjusting an amount of the macromonomers and a weight ratio of polymerizable monomer or an amount of a chain transfer agent, in polymerizing a toner composition including macromonomers containing a hydrophilic group, a hydrophobic group and at least one reactive functional group, and at least one polymerizable monomers, and then by mixing the polymer latex particles with a pigment dispersion solution.

According to another aspect of the present invention, an image forming apparatus is provided comprising a unit for charging an organic photoreceptor and a surface thereof, a unit for forming an electrostatic latent image on a surface of the organic photoreceptor, a unit for containing a toner, a unit for supplying the toner to the surface of the organic photoreceptor to develop the electrostatic latent image on the surface of the organic photoreceptor into a toner image, and a unit for transferring the toner image on the surface of the organic photoreceptor to a transfer medium, wherein the toner is prepared by forming polymer latex in which a molecular weight is controlled by adjusting an amount of the macromonomers and a weight ratio of polymerizable monomer, in polymerizing a toner composition including macromonomers containing a hydrophilic group, a hydrophobic group and at least one reactive functional group, and at least one polymerizable monomers, and then by mixing the polymer latex with a pigment dispersion solution.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an image forming apparatus including toner prepared according to an embodiment of the present invention;

FIG. 2 is a graph showing an average molecular weight of polymer latex particles obtained in Examples 1 through 3;

FIG. 3 is a graph showing a glass transition temperature of the polymer latex particles obtained in Examples 1 through 3;

FIG. 4 is a graph showing a size of polymer latex particles obtained in Examples 1 through 3; and

FIGS. 5 through 7 are scanning electron microscope (SEM) images of toner particles obtained in Examples 9 through 11.

### DETAILED DESCRIPTION OF THE INVENTION

The present invention will now be described more fully with reference to the accompanying drawings, in which exemplary embodiments of the invention are shown.

According to an embodiment of the present invention, a method of preparing toner is provided including preparing polymer latex particles by polymerizing a toner composition comprising macromonomers having a hydrophilic group, a hydrophobic group and at least one reactive functional group, and at least one polymerizable monomer, controlling a molecular weight and glass transition temperature (Tg) of the polymer latex by adjusting an amount of the polymer latex and a weight ratio of the polymerizable monomer or an amount of a chain transfer agent, and then mixing the obtained polymer latex with a pigment dispersion agent to control aggregation of the polymer latex particles.

In the method of preparing toner according to the current embodiment of the present invention, at least one type of polymer latex in which an emulsifying agent is not used, and its molecular weight and glass transition temperature (Tg) are controlled by polymerizing a macromonomer and a polymerizable monomer having a predetermined content is prepared. Then the polymer latex is mixed with a pigment dispersion solution in a predetermined ratio, and then a shape and size of toner particles are controlled by adjusting processing conditions, thus improving storage and durability of the toner.

The polymer latex having a controlled molecular weight is obtained by controlling an amount or a weight ratio of a macromonomer and/or polymerizable monomer used in a polymerization process. A desired toner shape (or shape factor) can be obtained and controlled using polymer latex whose molecular weight and glass transition temperature (Tg) are controlled independently. A shape and physical characteristics of the toner can be controlled by selecting at least two types of polymer latex whose molecular weight is controlled according to the process as described above. For example, when at least two types of polymer latex having different molecular weights by controlling their respective molecular weights are used, the weight ratio may be about 1:0.1-1:10, and preferably about 1:1-1:3.

Amounts of macromonomer and polymerizable monomer that can be used in a process of polymerizing the polymer latex will be described below.

The polymer latexes having different molecular weights in the current embodiment of the present invention can be prepared by changing an amount of a chain transfer agent in addition to an amount of the macromonomer and polymerizable monomer, or by changing a weight ratio between each monomer when a plurality of monomers are used in the polymerizable monomer. That is, a molecular weight of the polymer latex can be controlled by adjusting an amount of each monomer included in the chain transfer agent and polymerizable monomer which are added in a polymerization process in a predetermined ratio.

As described above, toner is prepared by preparing at least one type of polymer latex having a different molecular weight by controlling an amount of the macromonomer, an amount (or weight ratio) of polymerizable monomer or a content of a chain transfer agent, and by aggregating the polymer latex with a pigment dispersion solution. By optimizing such an aggregation process, a desired shape and size of toner particles can be controlled. At least two types of polymer latex having different molecular weights can be aggregated by controlling the pH, adjusting an amount of an inorganic salt added or optimizing various processing conditions such as boiling time, revolutions per minute (RPM) of a stirrer, the processing temperature or the like. Accordingly, the shape and size of toner particles are controlled and particle size distribution can be adjusted, and thus toner having a small particle size of about 5-8 μm can be easily prepared.

In the method of preparing toner according to the current embodiment of the present invention, at least one type of polymer latex having different molecular weights obtained by polymerizing the toner composition as described above starts to aggregate when pH is adjusted and controlled or an inorganic salt is added in an initial process of aggregation.

First, a method of controlling pH will be described in more detail. When alkali is added to at least two types of polymer latex having different molecular weights, thus increasing the pH of the polymer latex, a surface of polymer latex particles having a negative-charged, or a positive charge is decreased on a surface of polymer latex particles.

For example, the negative charge on the surface of the polymer latex particles is mainly derived from a macromonomer chain that is chemically bound to the surface of the polymer latex particles, a sulfate group of potassium persulfate which is used as an initiator, and an acid functional group used as a comonomer. When the surface of the polymer latex particles suddenly has a high negative value, that is, a high pH value or a high value (absolute value) of zeta potential, a repulsive force between polymer latex particles is strong, and thus aggregation does not occur. When the surface of the polymer latex particles has a low pH value or a low value (absolute value) of zeta potential, dispersion stability of polymer latex particles is decreased, and thus aggregation easily occurs.

Such pH control is performed by an addition of an acid or a base. Examples of the acid include, but are not limited to, sulfuric acid, hydrochloric acid, nitric acid, carbonic acid, acetic acid, phosphoric acid, and the like, and it is preferable that a strong acid is used to form abrupt aggregation. Thus, it is desired that a pH of a mixing solution including the polymer latex is controlled in a pH range of about 1-3. With such a low pH, the surface of the polymer latex particles has a low value of zeta potential as described above, and thus dispersion stability is decreased resulting in smooth aggregation. However, it is difficult for aggregation to be controlled so that aggregation is performed in an alkali region.

When aggregation produces the desired particle size, aggregation needs to be stopped to obtain toner particles having a desired narrow particle size distribution and a size of 5-8 μm, and thus the low pH needs to be adjusted to a high pH. For this, alkali is added to a mixing solution that is being mixed. Here, examples of the alkali include sodium hydroxide, potassium hydroxide, calcium hydroxide, barium hydroxide, and others. It is desirable that the alkali is added to adjust the dispersion to a pH in the range of about 10-12. With such a high pH, a negative charge is formed on the surface of toner particles, and thus a repulsive force between particles is strong resulting in bad aggregation. Therefore, extra or further aggregation can be inhibited, and thus toner can be controlled to have a desired particle size and particle size distribution.

Likewise, when an inorganic salt is added to polymer latex, a size of toner particles and the particle size distribution can be adjusted, and a size of toner particles becomes bigger due to ionic strength, collision between particles, and the like. In particular, when a concentration of the inorganic salt is greater than a critical coagulation concentration (CCC), an electrostatic repulsive force between polymer latex particles is offset, and thus aggregation rapidly occurs due to Brownian motion of the polymer latex particles. When a concentration of the inorganic salt is less than the CCC, aggregation speed is slow, and thus aggregation of polymer latex particles can be controlled. Here, examples of the inorganic salt include at least one selected from the group consisting of NaCl, MgCl₂, and Polyaluminum Chloride (PAC), but are not limited thereto.

In the current embodiment of the present invention, by controlling the pH or adjusting an amount of an inorganic salt added as described above, aggregation of the polymer latex particles is controlled to control a particle size and/or a particle size distribution of a finally obtained toner. In addition, pH control or addition of the inorganic salt can be performed independently or in combination. That is, by controlling pH and adding the inorganic salt at the same time, particle size and/or particle size distribution of a toner can be controlled.

In the aggregation process according to an embodiment of the present invention, temperature is also an important factor. Therefore, it is preferable that the aggregation process is performed at a temperature greater than the glass transition temperature (Tg) of each polymer latex used for aggregation. At a temperature greater than the Tg of a polymer latex, the Gibbs free energy of the polymer latex chain is increased, and thus the polymer latex can freely move to form toner particles having a smooth surface.

In addition, in the aggregation process, a boiling time or RPM while stirring is also a factor that determines a size and shape of toner particles. Such a boiling time or stir RPM depends on an amount of used raw materials, and can be appropriately selected according to a shape and size of desired final toner particles. Preferably, the boiling time is within a range of 1-24 hours, and the stir RPM is within a range of 200-500 RPM.

As described above, in the method of preparing toner according to the current embodiment of the present invention, a shape of finally obtained toner particles can be affected by an amount of a macromonomer used in a polymerization process of the polymer latex, and a molecular weight and Tg of a polymer latex is adjusted in the polymerization process by changing an amount of the macromonomer. In this way, a finally obtained toner shape can be controlled using polymer latexes having different molecular weights.

A macromonomer used as a comonomer used in an embodiment of the present invention has the advantage of stabilizing the polymer latex in an aqueous solution without an emulsifying agent in an aggregation process. By not using such an emulsifying agent, the amount of the discharged wastewater occurring in a washing process of an emulsifying agent is minimized, thus being environmentally friendly.

The macromonomers used in the current embodiment of the present invention are amphiphilic materials having both a hydrophilic group and a hydrophobic group, and are in the shape of a polymer or an oligomer having at least one reactive functional group at an end thereof.

The hydrophilic group of the macromonomers which is chemically combined on the surface of the polymer latex particles increases the long-term stability of the toner particles by steric stabilization, and can adjust the size of the polymer latex particles according to the amount or molecular weight of the injected macromonomers. The hydrophobic group of the macromonomers exists on the surface of the toner particles and can facilitate polymerization reaction. Macromonomers can shape copolymers by being bonded with polymerizable monomers contained in a toner composition by grafting, branching, or cross-linking.

The weight average molecular weight of the macromonomers according to the current embodiment of the present invention may be about 100 to 100,000, preferably about 1,000 to 10,000. When the weight average molecular weight of the macromonomers is less than 100, the properties of the toner are not improved or the toner cannot function efficiently as a stabilizer. When the weight average molecular weight of the macromonomers is greater than 100,000, the reaction conversion rate may be lowered.

The macromonomers may be a material selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate, but is not limited thereto.

An amount of the macromonomers may preferably be about 1-50 parts by weight based on 100 parts by weight of the total amount of a toner composition, more preferably about 1-20 parts by weight. When the amount of the macromonomers is less than 1 part by weight based on 100 parts by weight of the toner composition, the dispersion stability of the toner particles is reduced, and when the amount of the macromonomers is greater than 50 parts by weight, the properties of the toner are deteriorated.

Amphiphilic macromonomers can function not only as a copolymer but also as a stabilizer. Initial reaction of radicals and monomers creates oligomer radicals and shows an in-situ stabilization effect. An initiator dissolved by heat creates radicals and reacts with a monomer in an aqueous solution and the hydrophobicity increases. Such hydrophobicity of oligomer radicals facilitates diffusion into micelles and reaction with polymerizable monomers, and together with this, a copolymerization reaction with macromonomers can be processed.

Due to the hydrophilicity of the amphiphilic macromonomers, copolymerization can easily occur in the vicinity of the surface of the toner particles. The hydrophilic portions of the macromonomers located on the surface of the toner particles increase the stability of the toner particles by steric stabilization, and the size of the toner particles can be adjusted according to the amount or molecular weight of the macromonomers. Also, functional groups reacting on the surface of the toner particles can improve the frictional electricity of the toner.

The polymerizable monomer according to the current embodiment of the present invention can be selected from a vinyl monomer, a polar monomer having a carboxyl group, a monomer having an unsaturated polyester group, and a monomer having a fatty acid group. A molecular weight or Tg of polymer latexes obtained by appropriately adjusting an amount or use ratio thereof can be controlled.

The polymerizable monomer is at least one selected from the group consisting of styrene monomers such as styrene, vinyl toluene, α-methyl styrene; acrylate, methacrylate; derivatives of (meth)acrylates such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, methacryl amide; ethylenically unsaturated monoolefins such as ethylene, propylene, butylenes; halogenized vinyls such as vinyl chloride, vinylidene chloride, vinyl fluoride; vinyl esters such as vinyl acetate, vinyl propionate; vinyl ethers such as vinyl methyl ether, vinyl ethyl ether; vinyl ketones such as vinyl methyl ketone, methyl isoprophenyl ketone; and nitrogen-containing vinyl compounds such as 2-vinylpyridine, 4-vinylpyridine, N-vinyl pyrrolidone, but is not limited thereto. At least two kinds of the polymerizable monomers can be mixed together, and a molecular weight of the polymer latex can be dependent to a weight ratio of the used monomer materials.

The amount of the polymerizable monomer may preferably be about 3 to 95 parts by weight based on 100 parts by weight of the total amount of the toner composition, and more preferably about 50-90 parts by weight. When the amount of the polymerizable monomer is less than 3 parts by weight based on 100 parts by weight of the total amount of the toner composition, the yield of the toner is reduced. When the amount of the polymerizable monomer is greater than 95 parts by weight, the stability of the toner is reduced.

A medium used in the current embodiment of the present invention can be an aqueous solution, an organic solvent, or mixtures thereof.

A process of preparing a polymerization toner according to an embodiment of the present invention will be described as follows.

First, at least one polymer latex particle whose molecular weight is controlled is prepared by polymerizing a toner composition including macromonomers and polymerizable monomers. For example, while the inside of a reactor is purged with nitrogen gas, a medium such as a distilled deionized water (or a mixture of water and an organic solvent), or other solvents and a mixing solution of macromonomers are added to the reactor, and heated while stirring. At this time, an electrolyte such as NaCl or a other inorganic salt or other suitable electrolyte can be added to adjust ion strength of the reacting medium. When the temperature inside the reactor reaches a certain level, an initiator, preferably a water-soluble free radical initiator, is injected. Subsequently, at least one polymerizable monomer is injected into the reactor using a semi-continual method with a chain transfer agent, preferably. Here, polymerizable monomers are slowly provided in a starved condition process to adjust a reaction speed and dispersibility.

After the reaction is performed to a certain extent, a dispersion solution in which a mixing solution of wax and monomers is dispersed in a mixing solution of the macromonomers is injected into the reactor, and an initiator can be additionally injected to continue the reaction. The polymerization reaction time is within about 4-12 hours, is determined by temperature, experiment conditions, and by measuring reaction speed and conversion rate. After reaction, monomers are additionally added to adjust the durability of toner or other properties of the toner and to prepare polymer latex particles.

Then, aggregation of the polymer latex is performed. For this, a molecular weight of the polymer latex obtained in the polymerization process is controlled, a pigment solution dispersed by the macromonomers is injected while at least one polymer latex including wax is stirred at a certain speed, and then pH control and/or addition of an inorganic salt are performed to aggregate the polymer latex. To adjust the pH, an acid is added so that pH is adjusted and controlled in the range of pH 1-3, and then the resulting product is heated step by step. As a result, when a desired size of toner particles is obtained, pH is adjusted and controlled in the range of pH 10-13 to stop aggregation and the resulting product is heated at a predetermined temperature for a certain time to form a desired shape of toner particles.

When toner particles having a desired size and shape are obtained, the toner particles are cooled to a temperature of the Tg or less of the polymer latex, and then toner particles are separated and dried through a filtering process. An additive, such as silica or the like may be further added to the toner while regulating the electric charge, or other properties for use in a laser printer.

Processes of preparing the polymer latex particles and aggregating the same can minimize a washing process in processes of separation and filtration of prepared toner particles instead of using an emulsifying agent. By this, the process for preparing the toner is simplified, and thus a cost of preparing toner is reduced, and the amount of the discharged wastewater is minimized, thereby being environmentally friendly. In addition, by not using the emulsifier, problems such as sensitivity at high density, low triboelectric charge, low dielectricity, and weak toner flow can be prevented, and the storage stability of the toner can be improved remarkably.

A pigment used in the aggregation process can be carbon black or aniline black in the case of black toner. A nonmagnetic toner according to the current embodiment of the present invention is efficient for preparing color toner. For color toner, carbon black is used as a black colorant, and yellow, magenta, and cyan colorants are further included for colored colorants.

For the yellow colorant, a condensation nitrogen compound, an isoindolinone compound, anthraquinone compound, an azo metal complex, or an alyl imide compound is used. For example, C.I. pigment yellow 12, 13, 14, 17, 62, 74, 83, 93, 94, 95, 109, 110, 111, 128, 129, 147, 168, 180, and the like, can be used.

For the magenta colorant, a condensation nitrogen compound, an anthraquinone, quinacridone compound, base dye lake compound, naphthol compound, benzo imidazole compound, thioindigo compound, or perylene compound can be used. For example, C.I. pigment red 2, 3, 5, 6, 7, 23, 48:2, 48:3, 48:4, 57:1, 81:1, 122, 144, 146, 166, 169, 177, 184, 185, 202, 206, 220, 221, or 254, and the like, can be used.

For the cyan pigment, copper phthlaocyanine compound and derivatives thereof, anthraquinone compound, or base dye lake compound can be used. For example, C.I. pigment blue 1, 7, 15, 15:1, 15:2, 15:3, 15:4, 60, 62, or 66, and the like, can be used.

Such colorants can be used alone or in a combination of two colorants, and are selected in consideration of color, chromacity, luminance, resistance to weather, dispersion property in toner, and other properties.

The amount of the pigments as described above is preferably about 0.1 to 20 parts by weight, based on 100 parts by weight of the polymerizable monomer. The amount of the pigments should be sufficient to color the toner, however, when the amount of the pigment is less than 0.1 parts by weight based on 100 parts by weight of the polymerizable monomer, the coloring effect is not sufficient. When the amount of the pigments is greater than 20 parts by weight, the preparation costs of the toner increases, and thus sufficient frictional charge cannot be obtained.

The wax may be appropriately selected according to the purpose of the final toner. Examples of the wax that can be used include polyethylene-based wax, polypropylene-based wax, silicone wax, paraffin-based wax, ester-based wax, carbauna wax and, metallocene wax, but are not limited thereto. The melting point of the wax is preferably about 50-150° C. Wax constituents are physically attached to the toner particles, but are preferably not covalently bonded with toner particles. Thus, a toner that is fixed at a low fixing temperature on a final image receptor and shows excellent final image durability and resistance to abrasion is provided.

The toner according to the current embodiment of the present invention may further include at least one selected from a radical polymerization initiator, a chain transfer agent, a release agent, and a charge control agent.

The toner composition may create radicals due to the initiator and the radicals may react with the polymerizable monomer. The radicals can react with reactive functional groups of the macromonomers and shape copolymers.

Examples of the radical polymerization initiator include persulfate salts such as potassium persulfate, ammonium persulfate, and others; azo compounds such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1,1-bis(hydroxymethyl)-2-hydroxyethylpropioamide, 2,2′-azobis(2,4-dimethyl valeronitrile), 2,2′-azobis isobutyronitrile, 1,1′-azobis(1-cyclohexanecarbonitrile) etc.; peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, di-t-butylperoxy isophthalate, and others. Also, an oxidization-reduction initiator in which the polymerization initiator and a reduction agent are combined may be used.

A chain transfer agent defines a material that converts a type of a chain carrier in a chain reaction. A new chain has much less activity than that of a previous chain. The chain transfer agent can reduce polymerization of monomers and initiates a new chain. Due to an amount of the chain transfer agent used in the polymerization process, a molecular weight distribution of the polymer latex can be adjusted, and an amount of the chain transfer agent may be preferably less than about 10 parts by weight based on 100 parts by weight of the polymerizable monomer, and more preferably 1-10 parts by weight. When the amount of the chain transfer agent is greater than 10 parts by weight, the molecular weight of the polymer latex is lower.

Examples of the chain transfer agent include sulfur containing compounds such as dodecanthiol, thioglycolic acid, thioacetic acid, and mercaptoethanol; phosphorous acid compounds such as phosphorous acid and phosphorous natrium; hypophosphorous acid compounds such as hypophosphorous acid and hypophosphorous natrium; and alcohols such as methyl alcohol, ethyl alcohol, isopropyl alcohol, and n-butyl alcohol, but are not limited thereto.

The release agent can be used to protect a photoreceptor and prevent deterioration of developing, thereby obtaining a high quality image. A release agent according to an embodiment of the present invention may be a high purity solid fatty acid ester material. Examples of the release agent include low molecular weight polyolefins such as low molecular weight polyethylene, low molecular weight polypropylene, low molecular weight polybutylenes, and the like; paraffin wax; multi-functional ester compound, and the like. The release agent used in the current embodiment of the present invention may be a multifunctional ester compound composed of alcohol having three functional groups or more and carboxylic acid.

The polyhydric alcohol with at least three functional groups may be an aliphatic alcohol, such as glycerin, pentaerythritol, pentaglycerol, or the like; an alicyclic alcohol, such as chloroglycitol, quersitol, inositol, or the like; an aromatic alcohol, such as tris (hydroxymethyl) benzene, or the like; a sugar, such as D-erythrose, L-arabinose, D-mannose, D-galactose, D-fructose, sucrose, maltose, lactose, or the like; or a sugar-alcohol, such as erythrite, or the like.

The carboxylic acid may be an aliphatic carboxylic acid, such as acetic acid, butyric acid, caproic acid, enantate, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid, tetrolic acid, or the like; an alicyclic carboxylic acid, such as cyclohexanecarboxylic acid, hexahydroisophthalic acid, hexahydroterephthalic acid, 3,4,5,6-tetrahydrophthalic acid, or the like; or an aromatic carboxylic acid, such as benzoic acid, cumic acid, phthalic acid, isophthalic acid, terephthalic acid, trimeth acid, trimellitic acid, hemimellitic acid, or the like.

The charge control agent may be preferably selected from the group consisting of a salicylic acid compound containing metals such as zinc, aluminum, boron complexes of bis diphenyl glycolic acid, and silicate. More preferably, dialkyl salicylic acid boron, boro bis (1,1-diphenyl-1-oxo-acetyl potassium salt), and the like can be used.

According to another embodiment of the present invention, a toner composition including macromonomers containing a hydrophilic group, a hydrophobic group and at least one reactive functional group, and at least one polymerizable monomers is polymerized to prepare at least 2 polymer latex particles having different molecular weights. Then, toner obtained by aggregating the polymer latex particles with a pigment dispersion solution is provided.

The toner may be prepared without an emulsifying agent while the polymer latex particles are prepared and aggregated. A description of the toner according to the current embodiment of the present invention is the same as described above. A volume average diameter of the prepared toner particles is about 0.5-20 μm, and preferably about 45-8 μm.

According to another embodiment of the present invention, there is provided an image forming method, comprising: forming a visible image by disposing toner on a surface of a photoreceptor on which an electrostatic latent image is formed; and transferring the visible image to a transfer medium, wherein the toner is prepared by preparing at least one polymer latex particle whose molecular weight is controlled obtained by polymerizing a toner composition including macromonomers containing a hydrophilic group, a hydrophobic group and at least one reactive functional group, and at least one polymerizable monomer, and then by mixing the resulting product with a pigment dispersion solution.

A representative electrophotographic image forming process includes charging, exposure to light, developing, transferring, fixing, cleaning, and antistatic process operations, and a series of processes of forming images on a receptor.

In the charging process, a photoreceptor is covered with electric charge of desired polarity, negative or positive charges, by a corona or a charge roller. In the light exposing process, an optical system, conventionally a laser scanner or an array of diodes, selectively discharges the charged surface of the photoreceptor in an imagewise manner corresponding to a final visual image formed on a final image receptor to shape a latent image. Electromagnetic radiation that can be referred to as “light” includes infrared radiation, visible light, and ultraviolet radiation.

In the developing process, appropriate polar toner particles generally contact the latent image of the photoreceptor, and conventionally, an electrically-biased developer having identical potential polarity to the toner polarity is used. The toner particles move to the photoreceptor and are selectively attached to the latent image by electrostatic electricity, and shape a toner image on the photoreceptor.

In the transferring process, the toner image is transferred to the final image receptor from the photoreceptor, and sometimes, an intermediate transferring element is used when transferring the toner image from the photoreceptor to aid the transfer of the toner image to the final image receptor.

In the fixing process, the toner image of the final image receptor is heated and the toner particles thereof are softened or melted, thereby fixing the toner image to the final image receptor. Another way of fixing is to fix toner on the final image receptor under high pressure with or without the application of heat.

In the cleaning process, remaining toner on the photoreceptor is removed.

Finally, in the antistatic process, charges of a medium/body of the photoreceptor are exposed to light of a predetermined wavelength band and are reduced to a substantially uniform, low value, and thus the residue of the original latent image is removed, and the photoreceptor is prepared for a next image forming cycle.

According to another embodiment of the present invention, there is provided an image forming apparatus including a unit for charging an organic photoreceptor and a surface thereof; a unit for forming an electrostatic latent image on a surface of the organic photoreceptor; a unit for containing a toner; a unit for supplying the toner to the surface of the organic photoreceptor to develop the electrostatic latent image on the surface of the organic photoreceptor into a toner image; and a unit for transferring the toner image on the surface of the organic photoreceptor to a transfer medium, wherein the toner is prepared by forming at least 12 polymer latex particles by polymerizing a toner composition including a macromonomer and at least one polymerizable monomer having hydrophilicity, hydrophobicity, and at least one reactive functional group, and then by aggregating the polymer latex particles with a pigment dispersion solution.

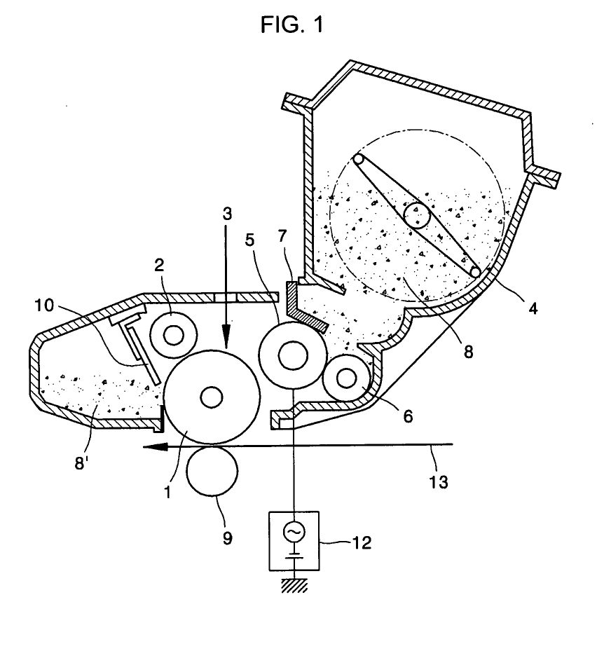

FIG. 1 is a schematic diagram of a non-contact developing type image forming apparatus using a toner prepared using the method according to an exemplary embodiment of the present invention. The operating principles of the image forming apparatus are explained below.

A developer 8, which is a nonmagnetic one-component developer, is supplied to a developing roller 5 through a feeding roller 6 formed of an elastic material such as a polyurethane foam or sponge. The developer 8 supplied to the developing roller 5 reaches a contact point between the developing roller 5 and a developer regulation blade 7 as the developing roller 5 rotates. The developer regulation blade 7 is formed of an elastic material such as metal, rubber, or the like. When the developer 8 passes the contact point between the developing roller 5 and the developer regulation blade 7, the developer 8 is smoothed to form a thin layer that is sufficiently charged. The developing roller 5 transfers the thin layer of the developer 8 to a developing domain where the thin layer of the developer 8 is developed on the electrostatic latent image of a photoreceptor 1, which is a latent image carrier.

The developing roller 5 and the photoreceptor 1 face each other with a constant distance therebetween. The developing roller 5 rotates counterclockwise and the photoreceptor 1 rotates clockwise. The developer 8 transferred to the developing domain forms an electrostatic latent image on the photoreceptor 1 according to the intensity of an electric charge generated due to a difference between a voltage applied to the developing roller 5 and a latent image potential of the photoreceptor 1.

The developer 8 developed on the photoreceptor 1 reaches a transferring device 9 as the photoreceptor 1 rotates. The developer 8 developed on the photoreceptor 1 is transferred through corona discharging or by a roller to a printing paper 13 as the printing paper 13 passes between the photoreceptor 1 and the transferring device 9. The transferring device 9 receives a high voltage with an opposite polarity to the developer 8, and thus forms an image.

The image transferred to the printing paper 13 passes through a fusing device (not shown) that provides high temperature and high pressure, and the image is fused to the printing paper 13 as the developer 8 is fused to the printing paper 13. Meanwhile, the developer 8 remaining on the developing roller 5 and which is not developed is transferred back to the feeding roller 6 contacting the developing roller 5. The above processes are repeated.

The present invention will be described in more detail with reference to the examples below, but is not limited thereto. The following examples are for illustrative purposes only and are not intended to limit the scope of the invention.

<Preparation of Polymer Latex>

### EXAMPLE 1

The inside of a reactor (1L) was purged with nitrogen gas and 470 g of distilled deionized water and 2.5 weight % (with respect to monomer) poly(ethylene glycol)-ethyl ether methacrylate (PEG-EEM, Aldrich) were added to the reactor and were agitated at 250 rpm and heated at the same time. When the inner temperature of the reactor reached 82° C., 2.0 g of potassium persulfate (KPS) was dissolved in 50 g of deionized water and introduced into the reactor as a water-soluble free radical initiator, and a monomer mixture of styrene, n-butyl acrylate, and methacrylic acid (weight ratio of 7:2:1 to 6.5:3.0:0.2, 100 g) and 1.98 g. of 1-dodecanethiol, a chain transfer agent, were added to the reactor in a starved-feeding way. During the reaction, 15 g of ester wax was heated in 28.1 g of a monomer mixture of styrene, butyl acrylate, and methacrylic acid (here, a weight ratio of 6.9:2.3:0.8) and 0.57 g of 1-dodecanthiol mixture solution and melted slowly, and dispersed in 190 g of distilled water and a macromonomer (PEG-EEM) mixture solution to the same ratio of the initial reaction to prepare a wax dispersion solution. The prepared wax dispersion solution was put into the reactor, and 1 g of KPS was dissolved in 40 g of deionized water and the resulted product was added to the reactor. The reaction time took 5 hours, and when the reaction was finished, the reactor was agitated and cooled naturally. The size of the polymer latex particles after the reaction was 250 to 500 nm, and the conversion rate was near 100%.

### EXAMPLE 2

Polymer latex particles were prepared in the same manner as in Example 1 except that 5.0 weight % of poly (ethylene glycol)-ethyl ether methacrylate (PEG-EEM, Aldrich) was used instead of 2.5 weight % thereof. The size of the polymer latex particles after the reaction was 250 to 500 nm, and the conversion rate was near 100%.

### EXAMPLE 3

Polymer latex particles were prepared in the same manner as in Example 1 except that 7.5 weight % of poly (ethylene glycol)-ethyl ether methacrylate (PEG-EEM, Aldrich) was used instead of 2.5 weight % thereof. The size of the polymer latex particles after the reaction was 250 to 500 nm, and the conversion rate was near 100%.

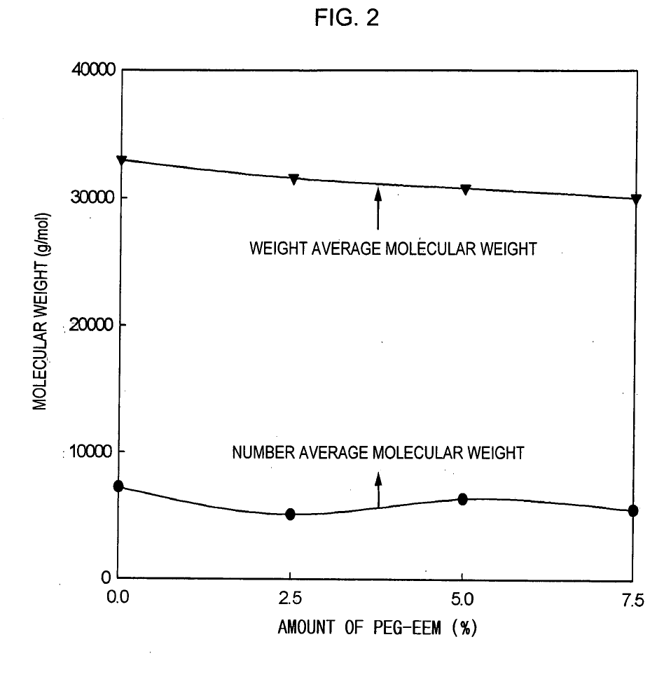

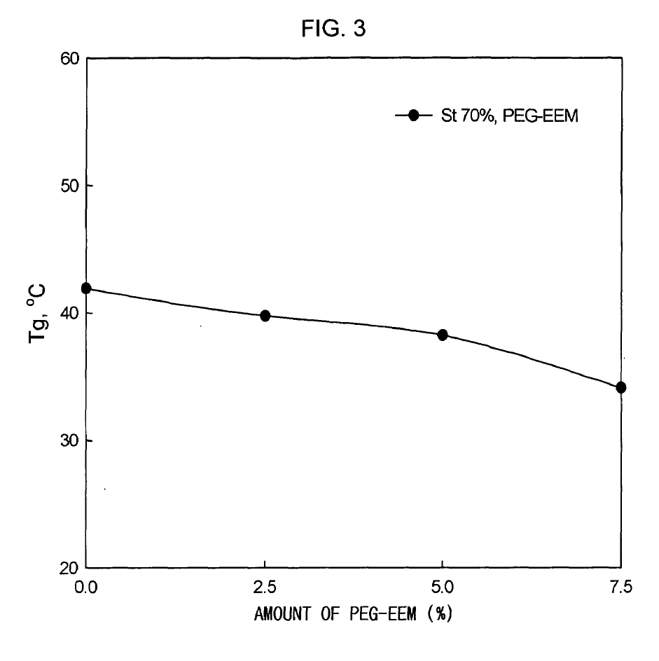

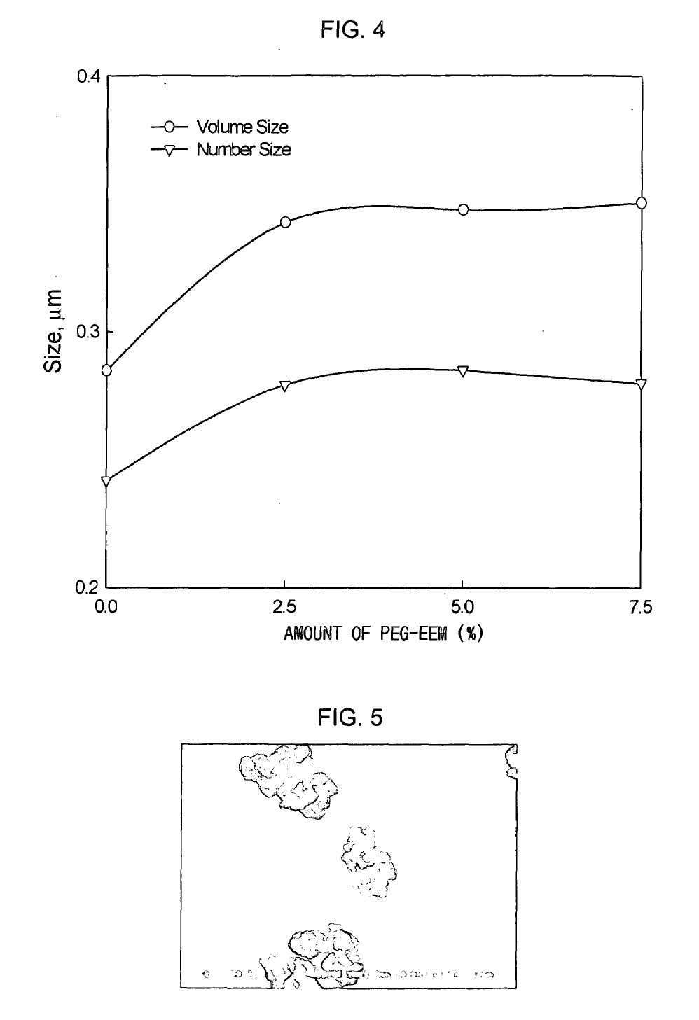

FIGS. 2 through 4 independently illustrate the number average molecular weight, weight average molecular weight, glass transition temperature (Tg), and size distribution of the polymer latex particles obtained in Examples 1 through 3. Referring to FIGS. 2 through 4, the molecular weight distribution, Tg and size distribution of obtained polymer monomers are changed by varying an amount of macromonomers in Examples 1 through 3.

### EXAMPLE 4

Polymer latex particles were prepared in the same manner as in Example 1 except that 1-dodecanethiol, a chain transfer agent, used in Example 1, was not used. The size of the polymer latex particles after the reaction was 250 to 500 nm, and the conversion rate was near 100%. A number average molecular weight and density of the prepared polymer latex particles are shown in Table 1 below.

### EXAMPLE 5

Polymer latex particles were prepared in the same manner as in Example 1 except that 3.00 g of 1-dodecanethiol, a chain transfer agent, used in Example 1, was used instead of 1.98 g thereof. The size of the polymer latex particles after the reaction was 250 to 500 nm, and the conversion rate was near 100%. A number average molecular weight and density of the prepared polymer latex particles are shown in Table 1 below.

### EXAMPLE 6

Polymer latex particles were prepared in the same manner as in Example 1 except that 4.00 g of 1-dodecanethiol, a chain transfer agent, used in Example 1, was used instead of 1.98 g thereof. The size of the polymer latex particles after the reaction was 250 to 500 nm, and the conversion rate was near 100%. A number average molecular weight and density of the prepared polymer latex are shown in Table 1 below.

### EXAMPLE 7

Polymer latex particles were prepared in the same manner as in Example 1 except that 5.00 g of 1-dodecanethiol, a chain transfer agent, used in Example 1, was used instead of 1.98 g thereof. The size of the polymer latex particles after the reaction was 250 to 500 nm, and the conversion rate was near 100%. A number average molecular weight and density of the prepared polymer latex particles are shown in Table 1 below.

### EXAMPLE 8

Polymer latex particles were prepared in the same manner as in Example 1 except that 7.00 g of 1-dodecanethiol, a chain transfer agent, used in Example 1, was used instead of 1.98 g thereof. The size of the polymer latex particles after the reaction was 250 to 500 nm, and the conversion rate was near 100%. A number average molecular weight and density of the prepared polymer latex particles are shown in Table 1 below.

TABLE 1

| Property | Example 4 | Example 1 | Example 6 | Example 7 | Example 7 | Example 8 |
|---|---|---|---|---|---|---|
| Number | 22,914 | 11,230 | 6,566 | 5,416 | 4,231 | 3,458 |
| average | | | | | | |
| molecular | | | | | | |
| weight | | | | | | |
| (g/mol) | | | | | | |
| Polydispersity | 2.01 | 6.70 | 7.61 | 8.19 | 8.70 | 10.54 |
| Index | | | | | | |

As shown in Table 1, as an amount of the chain transfer agent is increased, a molecular weight of the prepared polymer latex is decreased, and polydispersity index thereof is increased.

<Toner Preparation>

### EXAMPLE 9

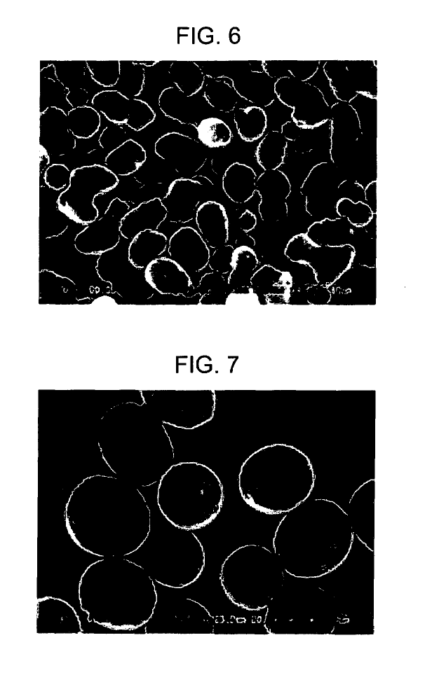

407 g of deionized water and 246 g of the polymer latex obtained in Example 1 were added to a 1L reactor and agitated at 300 rpm. During the agitation, 30 g of black pigment solution dispersed by 10 g of poly (ethylene glycol)-ethyl ether methacrylate (PEG-EEM, Aldrich), a macromonomer, was input. A hydrochloric acid as an acid was injected to the mixture solution and the pH of the overall solution was adjusted to pH 2 and slowly heated step by step. Here, when a volume average particle size of the toner was increased up to 7 μm, the pH of the overall solution was adjusted to pH 11 using a sodium hydroxide, and then the mixture solution was heated up to 95° C. When a desired particle shape was formed after 1 hour of reaction at 95° C., the temperature of the reaction result was cooled below the Tg of the polymer latex, and the toner particles were separated and dried through filtering. Silica was added to the dried toner, and the dry toner for a laser printer was finally obtained by adjusting the discharged electric charge. FIG. 5 is a scanning electron microscope (SEM) image of the obtained toner particles.

### EXAMPLE 10

The toner was prepared in the same manner as in Example 4 except that the polymer latex particles obtained in Example 2 were used instead of the polymer latex particles obtained in Example 1. FIG. 6 is a SEM image of the obtained toner particles.

### EXAMPLE 11

The toner was prepared in the same manner as in Example 4 except that the polymer latex particles obtained in Example 3 were used instead of the polymer latex particles obtained in Example 1. FIG. 7 is a SEM image of the obtained toner particles.

As can be seen in FIGS. 5 through 7, as an amount of the used macromonomers is changed, the shape of the toner particles changes. That is, when an amount of the macromonomers is changed, the polymer latex having a different molecular weight is obtained. According to such a change in the molecular weight of the polymer latexes, the modulus thereof also changes. Therefore, in the case of low molecular weight, circular toner particles are formed in an aggregation process, potato-shaped toner particles are formed if the molecular weight is slightly high, and irregular shaped toner particles are formed in the case of higher molecular weight.

### EXAMPLE 12

1,221 g of deionized water and 738 g of the polymer latex obtained in Example 1 were added to a 3 L reactor and agitated at 350 rpm. During the agitation, 30 g of black pigment solution dispersed by poly (ethylene glycol)-ethyl ether methacrylate (PEG-EEM, Aldrich), a macromonomer, was introduced. A hydrochloric acid was injected to the mixture solution and the pH of the overall solution was adjusted to pH 2 and slowly heated step by step. Here, when a volume average particle size of the toner was increased to 7 μm, the pH of the overall solution was adjusted to pH 11 using sodium hydroxide, and then the mixture solution was heated to 95° C. When a desired particle shape was formed after 2 hours of reaction at 95° C., the temperature of the reaction result was cooled below the Tg, and the toner particles were separated and dried through filtering. Silica was added to the dried toner, and a dry toner for a laser printer was finally obtained by adjusting the discharged electric charge.

### EXAMPLE 13

Toner was prepared in the same manner as in Example 12 except that a cyan pigment solution was used instead of a black pigment solution used in Example 12.

### EXAMPLE 14

Toner was prepared in the same manner as in Example 7 except that a magenta pigment solution was used instead of a black pigment solution used in Example 7.

### EXAMPLE 15

Toner was prepared in the same manner as in Example 12 except that a yellow pigment solution was used instead of a black pigment solution used in Example 12.

### EXAMPLE 16

1,221 g of deionized water and 738 g of the polymer latex obtained in Example 1 were added to a 3 L reactor and agitated at 300 rpm. During the agitation, 30 g of black pigment solution dispersed by poly (ethylene glycol)-ethyl ether methacrylate (PEG-EEM, Aldrich), a macromonomer, was introduced. At this time, the pH of the overall solution was adjusted to 11 and the resulting product was agitated for over 1 hour. Then, in an early aggregation process, 37.5 g of MgCl₂ was dissolved in 60 ml of deionized water, and the resulting product was added to the reactor and agitated. The temperature was increased to 85° C. step by step, and was maintained until a volume average particle size of the toner was increased to 5 μm. When a desired size of toner particles was obtained, the rotation speed was increased to 350 rpm and 120 g of NaCl was dissolved in 480 g of deionized water and added to the reactor. The temperature of the resulting product was increased to 95° C. and was maintained at this temperature for a further 2 hours. Then, when a toner having a volume average particle size of 7 μm and a number average particle size of 5 μm was formed, heating was stopped, the temperature of the reaction result was cooled below the Tg of the polymer latex and the toner particles were separated and dried through filtering. Silica was added to the dried toner, and a dry toner for a laser printer was finally obtained by adjusting the discharged electric charge.

### EXAMPLE 17

Toner was prepared in the same manner as in Example 16 except that a mixture of 370 g of the polymer latex particles obtained in Example 1 and 370 g of the polymer latex particles obtained in Example 2 was used instead of 738 g of the polymer latex particles obtained in Example 1.

### EXAMPLE 18

Toner was prepared in the same manner as in Example 16 except that a mixture of 300 g of the polymer latex particles obtained in Example 1 and 440 g of the polymer latex particles obtained in Example 2 was used instead of 738 g of the polymer latex particles obtained in Example 1.

### EXAMPLE 19

Toner was prepared in the same manner as in Example 16 except that a mixture of 200 g of the polymer latex particles obtained in Example 1 and 540 g of the polymer latex particles obtained in Example 2 was used instead of 738 g of the polymer latex particles obtained in Example 1.

### COMPARATIVE EXAMPLE 1

### Existing Emulsion/Aggregation Method

346 g of styrene-(n-butyl acrylate) copolymer latex particles polymerized using an emulsifying agent in advance was added to 307 g of ultrapure water in which an emulsifying agent was dissolved and agitated. The resulting product was mixed by adding 18.2 g of a pigment particle (Cyan 15:3, 40 weight %) aqueous solution dispersed with a SDS emulsifying agent and a wax dispersion solution dispersed by a SDS emulsifying agent, and agitated at 350 rpm. During the agitation, the pH of the latex pigment dispersion aqueous solution was set to pH 10 using 10% of NaOH buffer. synthesized using the above-described latex preparation process were added to a 1L reactor and agitated at 350 rpm. 30 g of ultrapure water was dissolved in 10 g of MgCl₂, flocculant, and then the resulting product was added to a latex pigment aqueous solution for about 10 minutes. Thereafter the temperature was increased to 95° C. When a toner having a desired particle size was obtained by heating for about 6-7 hours, the reaction was terminated and then the toner was naturally cooled. At this time, the volume average diameter of the obtained toner particles was 10.5 μm.

According to the present invention, the size or size distribution of toner particles, and the like can be controlled by both adjusting the shape of the toner particles using at least two polymer latexes having different molecular weights and controlling aggregation of polymer latex particles by pH control or by addition of an inorganic salt. Thus, toner having a small diameter can be easily prepared, fixation of toner to paper at a low temperature is improved by improved wax dispersibility, and the toner has improved properties such as storage, durability and the like. In addition, in preparing the toner, a washing process can be simplified, thus minimizing the amount of the discharged wastewater which is environmentally friendly.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing toner, the method comprising:
preparing polymer latex by polymerizing a toner composition comprising macromonomers containing a hydrophilic group, a hydrophobic group and at least one reactive functional group, and at least one polymerizable monomer, wherein the amount of the macromonomers and a weight ratio of the polymerizable monomer to the macromonomers are selected to obtain the polymer latex having a predetermined molecular weight and glass transition temperature (Tg); and
aggregating the resulting polymer latex particles with a pigment dispersion solution to obtain toner particle having a predetermined shape and size.

2. The method of claim 1, wherein the aggregation step further comprises:
mixing the polymer latex aggregation of the polymer latex.

3. The method of claim 2 wherein the first pH is about pH 1-3 and the second pH is about pH 10-12.

4. The method of claim 2 wherein the polymer latex particles have an average particle size of about 5-8 μm.

5. The method of claim 1, further comprising adding an inorganic salt to the pigment dispersion in an amount less than a critical coagulation concentration of the polymer latex particles.

6. The method of claim 1, wherein said toner composition produces at least two different polymer latex particles.

7. The method of claim 6, wherein said at least two different polymer latex particles have a different molecular weight.

8. The method of claim 1, wherein the toner composition further comprises a chain transfer agent, and the molecular weight of the polymer latex is controlled by adjusting the amount of the chain transfer agent.

9. The method of claim 1, wherein toner composition comprises a plurality of polymerizable monomers, and where the molecular weight of the polymer latex is controlled by changing a weight ratio of each polymerizable monomer with respect to the amount of the macromonomer.

10. The method of claim 1, wherein the aggregation of the polymer latex particles is accelerated by controlling the pH of the polymer latex in the range of about 1-3 when aggregating the polymer latex particles.

11. The method of claim 1, further comprising inhibiting the aggregation of the polymer latex particles by adjusting the pH of the polymer latex to about pH 10-12.

12. The method of claim 1, further comprising adding at least one inorganic salt to the aggregation step, and wherein the aggregation of the polymer latex particles is controlled by adjusting the amount of inorganic salt added in the aggregation process.

13. The method of claim 5, wherein the inorganic salt is at least one selected from the group consisting of NaCl, MgCl₂, and PAC.

14. The method of claim 1, wherein the aggregation is performed at a temperature above the glass transition temperature (Tg) of the polymer latex.

15. The method of claim 1, wherein the aggregation of the polymer latex particles is controlled by adjusting a heating time or a rotation speed of an agitator.

16. The method of claim 1, wherein the polymerization of the toner composition is carried out substantially in the absence of an emulsifying agent.

17. The method of claim 1, further comprising adding a dispersion of at least one polymerizable monomer and a wax in the polymerization process.

18. The method of claim 1, wherein the weight average molecular weight of the macromonomers is about 100-100,000.

19. The method of claim 1, wherein the macromonomers is selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate.

20. The method of claim 1, wherein the amount of the macromonomers is about 1-50 parts by weight based on 100 parts by weight of a toner composition.

21. The method of claim 1, wherein the polymerizable monomer is at least one selected from vinyl monomer, polar monomer having a carboxyl group, a monomer having an unsaturated polyester group, and a monomer having a fatty acid group.

22. The method of claim 1, wherein the polymerizable monomer is at least one selected from the group consisting of styrene, vinyl toluene, a-methyl styrene, acrylate, methacrylate; methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, methacryl amide, ethylene, propylene, butylenes, vinyl chloride, vinylidene chloride, vinyl fluoride, vinyl acetate, vinyl propionate, vinyl methyl ether, vinyl ethyl ether, vinyl methyl ketone, methyl isoprophenyl ketone; 2-vinylpyridine, 4-vinylpyridine, and N-vinyl pyrrolidone.

23. The method of claim 1, wherein the polymerizable monomer is selected from the group consisting of styrene monomers, (meth)acrylate derivatives, ethylenically unsaturated monoolefins, halogenated vinyls, vinyl esters, vinyl ethers, vinyl ketones, and nitrogen containing vinyl compounds.

24. The method of claim 1, wherein the step of preparing polymer latex further includes at least one selected from an initiator, a chain transfer agent, a charge control agent, and a release agent.

25. The method of claim 1, wherein the pigment dispersion solution is one selected from the group consisting of yellow, magenta, cyan, and black pigment.

26. The method of claim 1, wherein the molecular weigh of the polymer latex is sufficient low to produce substantially circular shaped toner particles.

27. The method of claim 1, wherein the molecular weight of the polymer latex is sufficiently high to produce substantially irregular shaped particles.

28. A toner obtained by using a method of claim 1.

29. A toner obtained by forming polymer latex particles having a molecular weight determined by an amount of macromonomers and a polymerizable monomer, wherein the toner is obtained by polymerizing a toner composition comprising the macromonomers having contain a hydrophilic group, a hydrophobic group and at least one reactive functional group, and at least one polymerizable monomer, and then mixing the resulting product with a pigment dispersion solution.

30. The toner of claim 29, wherein preparing and aggregating the polymer latex particles are performed substantially in the absence of a surfactant.

31. The toner of claim 29, wherein a volume average diameter of the toner particles is about 5-8 μm.

32. The toner of claim 29, wherein the macromonomers are selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate.

33. The toner of claim 29 further comprising at least one selected from an initiator, a chain transfer agent, a charge control agent, and a release agent.

34. An image forming method comprising:
forming a visible image by disposing the toner of claim 29 on an photoreceptor surface where an electrostatic latent image is formed; and
transferring the visible image to a transfer medium.

35. An image forming apparatus comprising:
an organic photoreceptor;
an image forming unit to form an electrostatic latent image on a surface of the organic photoreceptor;
a toner cartridge to contain the toner of claim 19;
a toner supplying unit to supply the toner to the surface of the organic photoreceptor to develop the electrostatic latent image on the surface of the organic photoreceptor into a toner image; and
a toner transferring unit to transfer the toner image from the surface of the organic photoreceptor to a transfer medium.
